(19) United States
(12) Patent Application Publication
(10) Pub. No.: US 2011/0286070 A1
(43) Pub. Date: Nov. 24, 2011

(54) MIRROR SWING RANGE CONTROL DEVICE OF LIGHT SCANNING APPARATUS

(75) Inventor: Kouji Hamachi, Nagano (JP)

(73) Assignee: SHINANO KENSHI KABUSHIKI KAISHA, Ueda-shi (JP)

(21) Appl. No.: 13/108,147

(22) Filed: May 16, 2011

(30) Foreign Application Priority Data
May 21, 2010 (JP) 2010-116873

(51) Int. Cl. G02B 26/10

(52) U.S. Cl. 359/225.1

(57) ABSTRACT

The mirror swing range control device is capable of reducing a production cost of the control device and precisely adjusting a swing range of a mirror section. The mirror swing range control device comprises: a swing range detecting section for detecting a swing range of the mirror section swung by driving the vibration source; a signal processing section for arithmetically processing a detection signal, which is generated by the swing range detecting section, so as to generate an inverted detection signal; a standard value generating section for generating a standard value signal indicating a standard time interval; a comparing section for adding the inverted detection signal to the standard value signal, integrating calculated errors and generating an error signal; and a swing range adjusting section for performing feedback control, in which a cancelling signal is applied to the drive circuit for a prescribed time when the comparing section generates the error signal, so as to cancel an increase-decrease value of the error signal.

### CROSS-REFERENCE TO RELATED APPLICATION

This application is based upon and claims the benefit of priority of the prior Japanese Patent Application No. P2010-116873, filed on May 21, 2010, and the entire contents of which are incorporated herein by reference.

### FIELD

The present invention relates to a mirror swing range control device of a light scanning apparatus, in which scanning operation is performed by reflecting a light beam irradiated from a light source with a swinging mirror section.

### BACKGROUND

A light scanning apparatus, which scans with a light, e.g., laser beam irradiated from a light source, is used in an optical equipment, e.g., barcode reader, laser printer, head mounted display, or an imaging equipment, e.g., infrared camera.

A conventional light scanning apparatus will be explained. A mirror section is provided in an opening part of a rectangular substrate, which is composed of, for example, stainless steel or silicon, and both sides of the mirror section are connected to the substrate by a beam section. A surface of the mirror section is polished like a mirror, reflection coating is formed on the surface of the mirror section, or a mirror is adhered thereon.

A vibration source, which is composed of a film of a piezoelectric substance, a magnetostrictive substance or a permanent magnet, is provided on the substrate. For example, in case of using the piezoelectric substance, the vibration source is extended by applying positive voltage and shrunk by applying negative voltage, so that the substrate is bent. By repeatedly bending the substrate upward and downward, twisting vibration is generated in the beam section, so that the mirror section can be swung on the beam section.

With this structure, great vibration can be generated in the mirror section by a small vibration source. Further, production cost can be lower than that of a conventional light scanning apparatus, in which a minute mirror produced by a micro electro mechanical system (MEMS) is swung (see Japanese Laid-open Patent Publication No. P2006-293116A).

To control the light scanning apparatus, two sensors, which respectively generate sensor signals, are located at both side limits of a scanning range of the mirror section. A time interval between the sensor signals of the two sensors, and the time interval is compared with a standard value of the time interval for feedback control so as to stabilize vibration of the mirror section. Voltage applied for vibrating the mirror section is adjusted and a swing range of the mirror section can be varied by the feedback control.

In case of measuring a time interval between the sensor signals of the sensors detecting the swing range of the mirror section by, for example, a time counter, if a scanning frequency is 2 kHz and an object jitter is 0.01%, resolution of the time counter is about 0.01 μsec. In light of detection errors, counting should be performed at 200-300 MHz, so a high speed time counter is required. In case of using a high speed time counter capable of operating at several hundred MHz, the time counter generates heat and is expensive. If an amount of heat generation of the time counter is great, a control device cannot be placed near an optical unit.

In the feedback control, a frequency component of jitter to be restrained is several hundred MHz and a sufficient sampling frequency is several kHz, so the feedback control can be realized by an inexpensive system. However, a measuring section for measuring the time interval must be expensive.

### SUMMARY

Accordingly, it is an object in one aspect of the invention to provide a mirror swing range control device of a light scanning apparatus which is capable of reducing a production cost of the control device and adjusting a swing range of a mirror section precisely.

To achieve the object, the mirror swing range control device of the present invention has following structure. Namely, the mirror swing range control device controls a light scanning apparatus, the light scanning apparatus includes: a rectangular substrate, whose one longitudinal end is clamped and held like a cantilever and in which a pair of tongue-shaped parts are formed at a free end and an opening part is formed between the tongue-shaped parts; a mirror section being provided in the opening part and supported by a beam section; and a drive circuit supplying a drive voltage to a vibration source provided on the substrate so as to vibrate the substrate, swing the mirror section on the beam section which acts as a pivot shaft and reflect irradiated light for light scanning,

the mirror swing range control device comprises:

a swing range detecting section having a first sensor and a second sensor, which are provided in a swing range of the mirror section vibrated by the vibration source and which respectively generate a first sensor signal and a second sensor signal, the swing range detecting section detecting the swing range of the mirror section on the basis of a detection signal, which is generated on the basis of a time interval between the first and second sensor signals;

a signal processing section generating an inverted detection signal, which is generated by inverting the detection signal by an inverter circuit;

a standard value generating section generating a standard value signal indicating a standard time interval;

a comparing section having an adder, which adds the inverted detection signal to the standard value signal generated by the standard value generating section when the inverted detection signal is inputted to a flip-flop, the comparing section integrating calculated errors and generating an error signal; and

a swing range adjusting section sending a command for adjusting amplitude of an electric signal having a drive frequency generated by a frequency generating section to the drive circuit so as to cancel an increase-decrease value of the error signal, and

the drive circuit performs a feedback control to adjust the swing range of the mirror section, via the vibration source, on the basis of the command from the swing range adjusting section.

Preferably, the swing range detecting section generates the detection signal on the basis of a time interval between a first sensor signal and a second sensor signal indicating detection of ends of the swing range, and

the detection signal is inverted, by an inverter circuit of the signal processing section, so as to generate the inverted detection signal.

Preferably, the comparing section generates the error signal, which indicates a difference between the integrated value of the errors obtained by adding the inverted detection signal generated by the signal processing section to the standard value signal generated by the standard value generating section, and a standard voltage.

In the present invention, the signal processing section arithmetically processes the detection signal, which has been generated by the swing range detecting section, so as to generate the inverted detection signal by the inverted circuit. Further, the comparing section adds the inverted detection signal, which has been generated by the signal processing section, to the standard value signal, which has been generated by the standard value generating section, integrates the calculated errors and generates as the error signal. The swing range adjusting section sends the command for adjusting amplitude of the electric signal having the drive frequency generated by the frequency generating section to the drive circuit so as to cancel the increase-decrease value of the error signal. With this structure, a high performance time counter, which is used for measuring a time interval between detection signals and whose generation of heat is great, is not required. Therefore, a production cost of the mirror swing range control device can be reduced without reducing accuracy of the feedback control of the swing range. Further, by reducing generation of heat, so that the mirror swing range control device can be placed near an optical unit.

### BRIEF DESCRIPTION OF THE DRAWINGS

Embodiments of the present invention will now be described by way of examples and with reference to the accompanying drawings, in which:

FIG. 1A is a plan view of a light scanning apparatus;

FIG. 1B is a sectional view taken along a line A-A shown in FIG. 1A;

FIG. 2 is an explanation view of sensors for detecting a swing range of a mirror section and sensor signals outputted from sensors;

FIG. 3 is a block diagram of a mirror swing range control device of the light scanning apparatus;

FIG. 4 shows waveform charts indicating relationship between the swing range and an adjusting voltage;

FIG. 5 is a block diagram of a signal processing section and a comparing section; and

FIGS. 6A-6C show timing charts of the signal processing section shown in FIG. 5.

### DETAILED DESCRIPTION OF THE EMBODIMENTS

Preferred embodiments of the present invention will now be described in detail with reference to the accompanying drawings. In the following embodiments, a scanner for a laser beam printer will be explained as a light scanning apparatus.

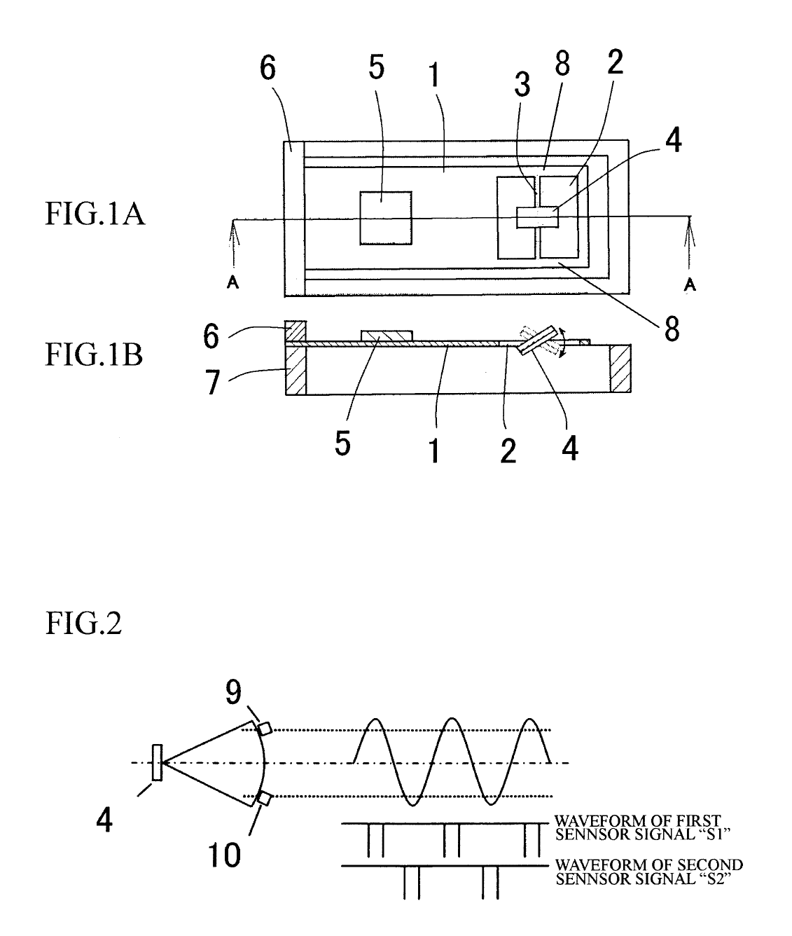

An outline of the light scanning apparatus will be explained with reference to FIGS. 1A and 1B.

A substrate 1 is a rectangular plate composed of, for example, stainless steel (SUS304), silicon (Si), etc. One longitudinal end of the substrate 1 is clamped by a clamping member 6 and a holding member 7, so that the substrate 1 is held like a cantilever.

A pair of frame parts 8 are formed at the other end (free end) of the substrate 1.

A mirror section (an optical MEMS mirror) 4 is provided in an opening part 2, which is formed between the frame parts 8, and both sides of the mirror section 4 are supported by a beam section 3.

A vibration source 5 is provided on the substrate 1 and located close to the one end side the substrate 1. The vibration source 5 is a piezoelectric element composed of lead zirconate titanate (PZT) and adhered to the substrate 1. The substrate 1 is vibrated by actuating the vibration source 5, so that the mirror section 4 can be swung, on the beam section 3 as a pivot shaft, with reflecting a laser beam. With this action, the light scanning operation can be performed.

Besides the piezoelectric element, a film of a piezoelectric substance, a magnetostrictive substance or a permanent magnet may be directly formed on the substrate 1 as the vibration source 5. The film may be formed by a known film forming method, e.g., aerosol deposition (AD) method, vacuum evaporation method, sputtering method, chemical vapor deposition (CVD) method, sol-gel method. By directly forming the film of a piezoelectric substance, a magnetostrictive substance or a permanent magnet on the substrate 1, a light scanning apparatus, which is driven at a low voltage and whose electric power consumption is low, can be produced.

In case of employing a magnetostrictive substance or a permanent magnet as the vibration source, by applying alternate magnetic fields to a coil located in the vicinity of the film of the magnetostrictive substance or permanent magnet formed on the substrate, an alternate current passes through the coil, so that alternate magnetic fields are generated. Note that, in case of forming the film of the magnetostrictive substance or permanent magnet formed on the substrate, a nonmagnetic material is suitably selected as a material of the substrate 1 so as to efficiently bend the substrate.

Note that, the mirror section 4 has a base plate. The base plate may be a metal plate whose surface is mirror-finished. In case that the base plate is composed of a non-metallic material or the base plate having high reflexivity is required, a thin mirror film may be formed on the base plate by a known film forming method, e.g., vacuum evaporation method, sputtering method, chemical vapor deposition (CVD) method, or by adhering a mirror surface member thereon.

The thin mirror film is composed of a material selected from gold (Au), silicon dioxide (SiO₂), aluminum (Al) and magnesium fluoride (MgF₂), or a combination of two or more. Further, by suitably controlling a thickness of a single-layer film or a total thickness of a multilayer film, reflexivity of the thin mirror film can be improved. For example, the mirror surface member to be adhered onto the mirror section 4 may be produced by forming the thin mirror film on a mirror-finished ceramic plate, e.g., silicon (Si), alumina titanium carbide (Al₂O₃—TiC), by said known film forming method.

In case that the base plate is composed of silicon (Si), stainless steel (e.g., SUS304), etc. or carbon nanotubes will be grown on the base plate, a desired thickness of the base plate is 10 μm or more in light of flatness of the mirror section 4 in operation and a required mirror size of a projector device, etc.

As shown in FIG. 2, a first photoelectronic sensor 9 and a second photoelectronic sensor 10 are placed to correspond both ends of a swing range of the mirror section 4. The first and second sensors 9 and 10 act as a swing range detecting section. When the first sensor 9 senses reflected light, the first sensor 9 outputs a first sensor signal S1; when the second sensor 10 senses reflected light, the second sensor 10 outputs a second sensor signal S2.

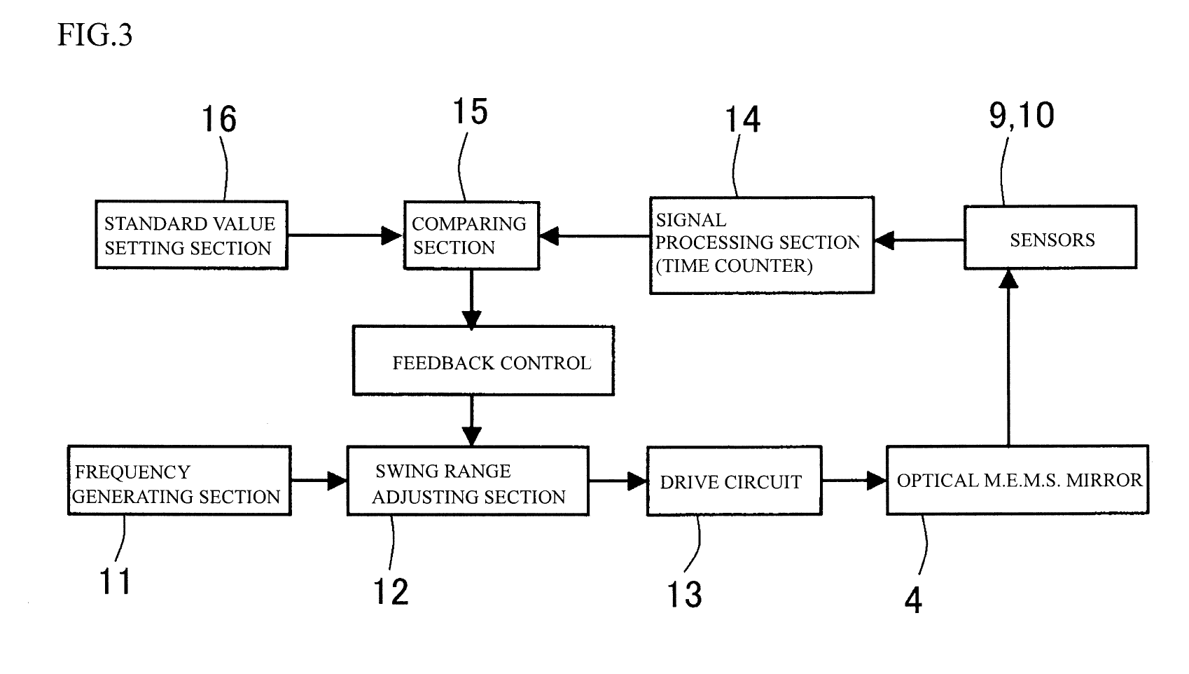

Next, a concrete example of a mirror swing range control device of the light scanning apparatus will be explained with reference to a block diagram of FIG. 3. In the control device, a time interval between the first sensor signal S1 and the second sensor signal S2 is measured, and the measured time interval is compared with a standard time interval so as to perform feedback control, so that the swing range of the mirror section 4 can be stabilized. The structure of the control device and the feedback control will be explained.

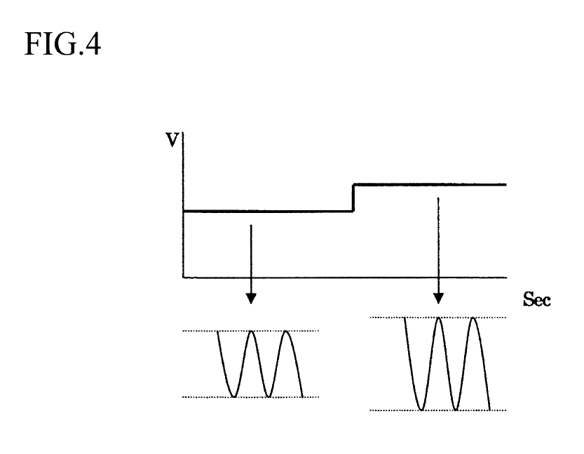

In FIG. 3, a frequency generating section 11 generates electric signals having a drive frequency. A swing range adjusting section 12 adjusts amplitude of the electric signals and sends the adjusted electric signals to a drive circuit 13. The drive circuit 13 applies a drive voltage, which corresponds to the adjusted amplitude of the electric signals sent from the swing range adjusting section 12, to the vibration source 5 so as to drive the vibration source 5. Therefore, the mirror section 4 is swung on the beam section 3. The first and second photoelectronic sensors 9 and 10, which act as the swing range detecting section, detect the swing range of the mirror section 4 swung by applying the drive voltage from the drive circuit 13 to the vibration source 5. A signal processing section 14 arithmetically processes a detection signal, which is obtained from the first and second sensor signals S1 and S2 generated by the first and second sensors 9 and 10, and generates an inverted detection signal through a logical circuit. A comparing section 15 adds the inverted detection signal, which has been generated by the signal processing section 14, to a standard value signal, which has been generated by a standard value generating section 16, integrates calculated error sand generates as an error signal. The swing range adjusting section 12 calculates an adjusting voltage, as shown in FIG. 4, so as to cancel the increase-decrease value of the error signal generated by the comparing section 15, and sends a command for adjusting amplitude of the electric signal having the drive frequency generated by the frequency generating section 11 to the drive circuit 13. The drive circuit 13 adjusts the swing range of the mirror section 4, via the vibration source 5, on the basis of the command from the swing range adjusting section 12.

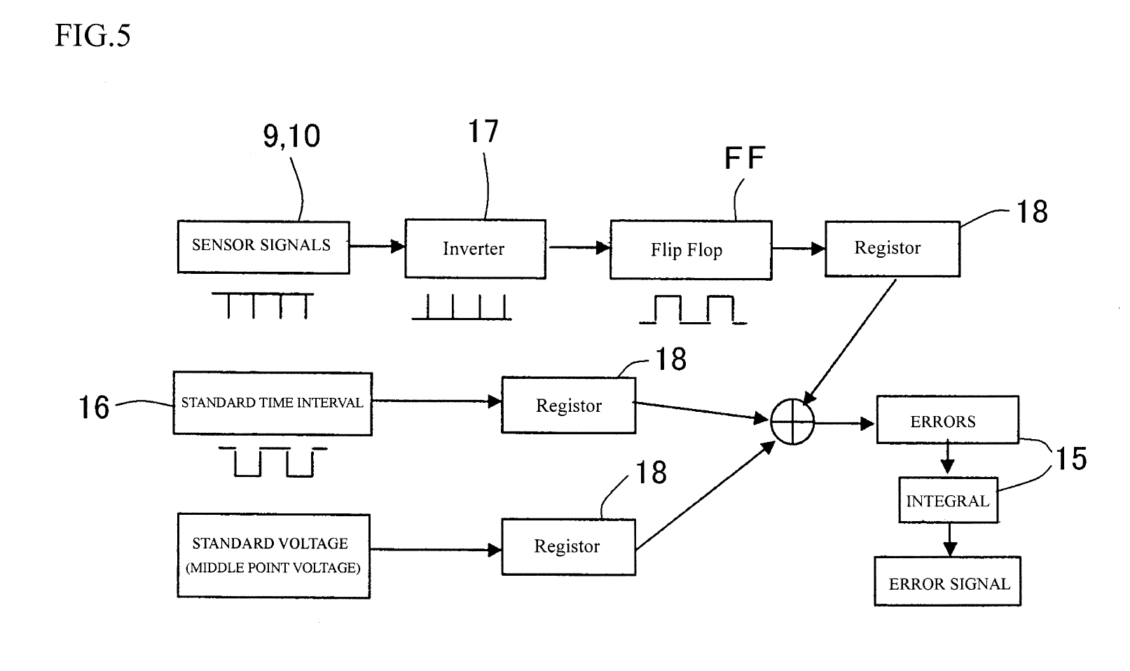

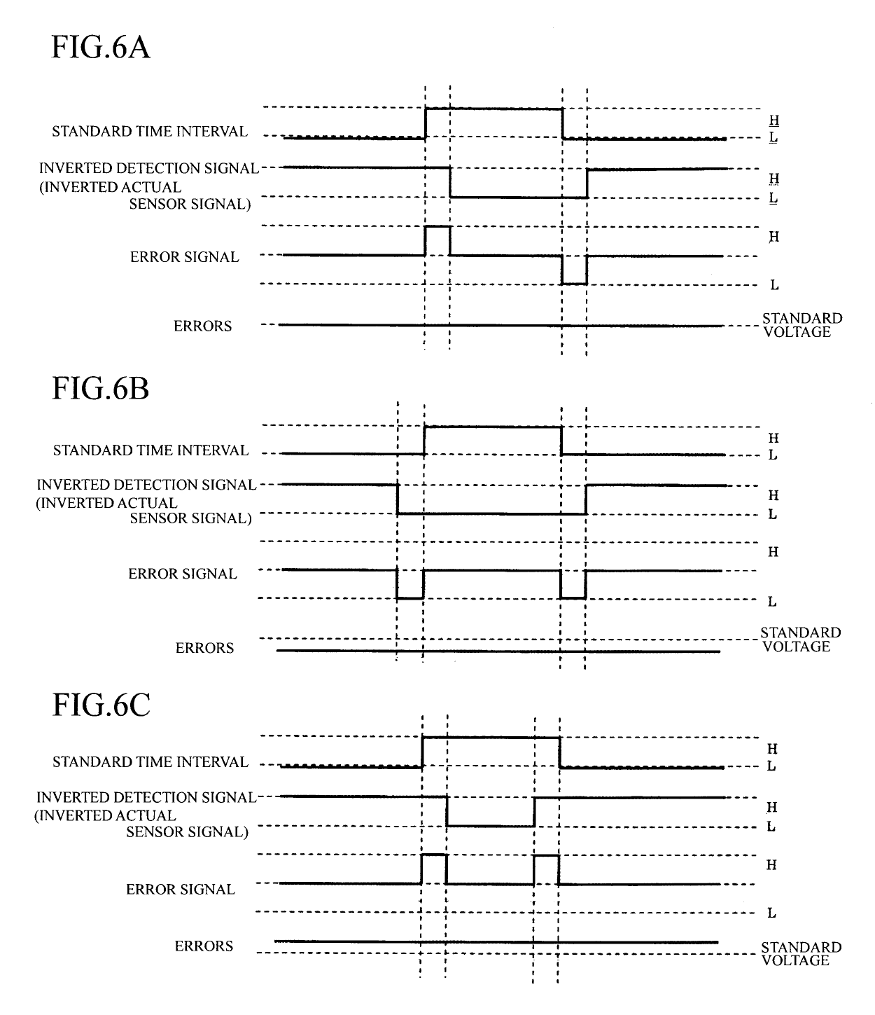

Next, an example of the signal processing section 14 will be explained with reference to FIG. 5 (block diagram) and FIGS. 6A-6C (timing charts).

In FIG. 5, the detection signal (interval signal) indicating a time interval between the first and second sensor signals S1 and S2 generated by the first and second sensors 9 and 10 is inputted to the logical circuit 17, i.e., inverter circuit (NOT circuit). The inverter circuit 17 generates the inverted detection signal (see FIG. 6A). Upon inputting the inverted detection signal to a flip-flop FF, a calculation command is sent to an adder (register) 18.

In FIG. 5, the register 18 of the comparing section 15 adds the inverted detection signal generated by the inverter circuit 17 to the standard value signal generated by the standard value generating section 16 so as to calculate errors. The calculated errors are integrated to generate the error signal. The error signal indicates a difference between the integrated value of the calculated errors and a standard voltage (middle point voltage) (see FIGS. 6B and 6C). The error signal is inputted to the swing range adjusting section 12. The swing range adjusting section 12 applies a cancelling signal to the drive circuit 13 for a prescribed time so as to cancel an increase-decrease value of the error signal, so that the feedback control can be performed.

In FIG. 6A, the time interval between the sensor signals is equal to a standard time interval. Namely, no errors of the swing range of the mirror section 4 are observed. In this case, the integrated value of the calculated errors is zero and equal to the standard voltage. Therefore, no error signal is generated.

In FIG. 6B, the time interval of between the sensor signals is longer than the standard time interval. Namely, the swing range of the mirror section 4 is greater than a standard value thereof. In this case, the integrated value of the calculated errors is smaller than zero. Therefore, the error signal lower than the standard voltage is generated.

In FIG. 6C, the time interval of between the sensor signals is shorter than the standard time interval. Namely, the swing range of the mirror section 4 is smaller than a standard value thereof. In this case, the integrated value of the calculated errors is greater than zero. Therefore, the error signal higher than the standard voltage is generated.

As described above, a high performance time counter, whose generation of heat is great, need not be required to measure the time interval between the signals S1 and S2 of the first and second photoelectronic sensors 9 and 10. Therefore, a production cost of the mirror swing range control device can be reduced, and the swing range of the mirror section 4 can be precisely controlled. Further, generation of heat can be restrained, so that the mirror swing range control device can be placed near an optical unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alternations could be made hereto without departing from the spirit and scope of the invention.

What is claimed is:

1. A mirror swing range control device of a light scanning apparatus, the light scanning apparatus including: a rectangular substrate, whose one longitudinal end is clamped and held like a cantilever and in which a pair of tongue-shaped parts are formed at a free end and an opening part is formed between the tongue-shaped parts; a mirror section being provided in the opening part and supported by a beam section; and a drive circuit supplying a drive voltage to a vibration source provided on the substrate so as to vibrate the substrate, swing the mirror section on the beam section which acts as a pivot shaft and reflect irradiated light for light scanning,
the mirror swing range control device, comprising:
a swing range detecting section having a first sensor and a second sensor, which are provided in a swing range of the mirror section vibrated by the vibration source and which respectively generate a first sensor signal and a second sensor signal, the swing range detecting section detecting the swing range of the mirror section on the basis of a detection signal, which is generated on the basis of a time interval between the first and second sensor signals;
a signal processing section generating an inverted detection signal, which is generated by inverting the detection signal by an inverter circuit;
a standard value generating section generating a standard value signal indicating a standard time interval;
a comparing section having an adder, which adds the inverted detection signal to the standard value signal generated by the standard value generating section when the inverted detection signal is inputted to a flip-flop, the comparing section integrating calculated errors and generating an error signal; and
a swing range adjusting section sending a command for adjusting amplitude of an electric signal having a drive frequency generated by a frequency generating section to the drive circuit so as to cancel an increase-decrease value of the error signal,
wherein the drive circuit performs a feedback control to adjust the swing range of the mirror section, via the vibration source, on the basis of the command from the swing range adjusting section.

2. The mirror swing range control device according to claim 1,
wherein the swing range detecting section generates the detection signal on the basis of a time interval between a first sensor signal and a second sensor signal indicating detection of ends of the swing range, and
the detection signal is inverted, by an inverter circuit of the signal processing section, so as to generate the inverted detection signal.

3. The mirror swing range control device according to claim 1,
wherein the comparing section generates the error signal, which indicates a difference between the integrated value of the errors obtained by adding the inverted detection signal generated by the signal processing section to the standard value signal generated by the standard value generating section, and a standard voltage.

4. The mirror swing range control device according to claim 2,
wherein the comparing section generates the error signal, which indicates a difference between the integrated value of the errors obtained by adding the inverted detection signal generated by the signal processing section to the standard value signal generated by the standard value generating section, and a standard voltage.
